(19) United States
(12) Patent Application Publication
(10) Pub. No.: US 2007/0291775 A1
(43) Pub. Date: Dec. 20, 2007

(54) Self-Adapting Bandwidth Management

(76) Inventor: Michael Frantz, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/663,242

(22) PCT Filed: Sep. 6, 2005
(86) PCT No.: PCT/EP05/54388

§ 371 Date: Mar. 19, 2007

(30) Foreign Application Priority Data
Sep. 21, 2004 (DE) 10 2004 045 740.9

(51) Int. Cl. H04L 12/56

(52) U.S. Cl. 370/401

(57) ABSTRACT

The bandwidth of a server channel is adapted when the summated bandwidth of the client channels guided in the server channel is modified. As a result, it is possible to minimize bandwidths which are linked by preventively maintained broadband server channel in a communication network.

### CROSS REFERENCE TO RELATED APPLICATIONS

This application is the US National Stage of International Application No. PCT/EP2005/054388, filed Sep. 6, 2005 and claims the benefit thereof. The International Application claims the benefits of German application No. 102004045740.9 DE filed Sep. 21, 2004, both of the applications are incorporated by reference herein in their entirety.

### FIELD OF INVENTION

The present invention relates to a self-adapting bandwidth management.

### BACKGROUND OF INVENTION

The international standard M.3010 (02/2000) of the ITU-T describes a reference architecture of a telecommunications management network (TMN) for monitoring and controlling a network for telecommunications applications in which it is assumed that the network controlled by the TMN comprises different types of network elements which are usually controlled with the aid of different communication mechanisms (i.e. protocols, messages, management information—also termed object model).

This TMN comprises the following functionalities:

Operations Systems Function (OSF), which implements the “actual” management of the telecommunications network.

Workstation Function (WSF), which serves for visualizing the control processes and the network status for a human user of the TMN.

Network Element Function (NEF), which represents an interface for controlling the telecommunications functions of the network elements. The interface defines the specific communication mechanism of the respective network element, which mechanism may not be standardized. The sum of all the management information of the NE is referred to as the Management Information Base (MIB) of the NE. It is also referred to hereinafter as the NE-MIB.

Transformation Function (TF), which is used for connecting components with different communication mechanisms and in particular for connecting network elements which have no standardized NEF to the TMN. It is also referred to in the M.3010 standard (05/96) as the Mediation Function or as the Q-Adaption Function.

The functionalities are further classified as far as possible into the following groups according to the FCAPS scheme:

F=Fault

C=Configuration

A=Accounting

P=Performance

S=Security

The functions are realized by physical products which can be embodied, for example, as a network element (NE), operations system (OS), application, terminal, router, switch, database server or computer program (i.e. more accurately: “computer program product”), but are not, of course, limited to these.

The NEF function is usually assigned to an NE, while the OSF and WSF functions are mostly assigned to an OS. Typically, one OS is assigned a plurality of NEs, in which case the OS is mostly centralized, while the NEs are distributed in the network in a decentralized manner over a plurality of locations.

A data communication network (DCN) for transmitting information can be provided between NE and OS. The transmission follows the principles of the transport service, as described in the lower layers of the ISO/OSI reference model in the international standard X.200.

An OS can comprise a plurality of programs—also called applications or software. The programs can be embodied for example as management applications for controlling different network technologies of a communications network and by which an application-specific subset of the resources of the network that is relevant to the technology controlled in each case is modeled, visualized and controlled in each case.

The programs are executed by hardware (e.g. processor, I/O module) which is provided in the products. This embodiment is supported by support software (e.g. multitasking or, as the case may be, multithreading operating system, database system, Windows system).

The configuration functionality of the communications network provides, for example, that channels (also called paths, trails, connections or services) are set up and managed in the network elements with the aid of the OS. These channels are frequently set up step by step and at the same time often even layer by layer in that initially channels of a lower layer (e.g. SDH Trail, ATM VP [=Virtual Path]) are switched, with channels of a higher layer (e.g. Ethernet Service, ATM VC [=Virtual Channel]) then being inserted into these. In this arrangement the channels are in a client-server relation with one another, the channels of the lower layer acting as server channels and those of the higher layer as client channels.

### SUMMARY OF INVENTION

In the light of what has been said thus far it becomes clear that implementing the architecture described in real solutions represents a highly complex technical problem, given the marked distributed nature of the system and the multiplicity of different system components and requirements.

An object of the invention is to identify at least one of the existing problems and provide a solution by specifying at least one directive for technical actions.

The invention is based on the following knowledge:

Conventionally, each server channel is set up with a fixed bandwidth, the size of which is chosen sufficiently large so that a specific expected maximum number of client channels can be inserted. A server channel into which its maximum number of client channels has been inserted is used to its full capacity. In this case no further client channels can be inserted into this server channel. This also applies when there is still capacity present for further client channels in other server channels or essentially in the communications network as a whole.

The configuration of networks of this type is supported by contemporary operations systems in that when a new client channel is set up, those server channels are selected and offered which still have sufficient bandwidth available for the new client channel. Server channels without sufficient (residual) bandwidth are not displayed.

A change or, as the case may be, adjustment of the bandwidth of a server channel is possible only with a disproportionate amount of effort. It usually requires all the client channels contained therein as well as the existing server channel to be de-installed and then a new server channel to be set up with the desired, changed bandwidth, into which server channel the previous client channels are then reinserted. Moreover, while this change is being carried out, no transmission of information is possible in the client channels deleted in the interim. In other words, therefore, the result is a temporary interruption to traffic.

An early optimal dimensioning of the server channels is difficult, since the subsequent actual utilization of the server channels often cannot be predicted with very great accuracy. If the server channels are then loaded with a plurality of client channels during operation, a change is—as described above—subsequently only possible to a very limited degree.

It is therefore a longstanding, well-established rule that no automated change of the bandwidth of heavily used server channels is supported by an operations system, but rather that said server channels—as described—are, where applicable, no longer selected and offered for the purpose of setting up new client channels.

The Link Capacity Adjustment Scheme (LCAS) was developed for SDH networks at the ITU-T. The scheme is described in the ITU-T recommendations G.7042 and Y.1305 as well as their respective supplementary recommendations. LCAS is based on virtually concatenated SDH trails—also called VCG (=Virtual Concatenated Group) or LcasGroupTrail—which collectively serve for transmitting information and act from the perspective of the client channels like a homogeneous server channel. In this scheme the individual SDH trails can also take different paths through an SDH network. Among other things LCAS allows the bandwidth of an LcasGroupTrail to be increased or reduced without interruption. Failures of individual trails are also compensated to a certain extent, since not all SDH trails of a VCG have to be active simultaneously.

The effect of server channels with adjustable bandwidth on the configuration management has remained an unresolved issue to date. To recognize and investigate this necessitates a departure from the described previous long-established approach of not loading full server channels any further with client channels. Automatic bandwidth adjustment is not supported by the prior art configuration management. It must be solved manually by the operator by means of a time-consuming, error-prone monitoring and configuration process as described above.

Methods such as LCAS for example are suitable for departing from the prior art standard approach and taking new paths in the loading of server channels whose essentially permanently configured bandwidth is initially not sufficient for accommodating further client channels.

A solution for this problem situation identified according to the invention as well as advantages embodiments of this solution are set forth in the claims.

### BRIEF DESCRIPTION OF THE DRAWINGS

The invention is explained below with reference to exemplary embodiments which are also illustrated in the figures. It should be emphasized that in spite of their sometimes very detailed representation the embodiments of the invention shown are merely exemplary in nature and are not to be understood as limiting. The figures show:

FIG. 1 an exemplary arrangement, comprising a central operations system OS with applications A for controlling decentralized elements NE of a communications network KN

FIG. 2 an exemplary layering of multiple channels K, wherein the channels K of a higher layer are conveyed in the next lower layer in each case and the channels are mostly conveyed via multiple elements NE of the communications network KN

FIG. 3 an exemplary server channel K₁ of an LCAS transport system in which a plurality of client channels K₂ are conveyed

FIG. 4 the exemplary server channel K₁ of the previous figure following an inventive adjustment to a new, in this case higher, bandwidth

### DETAILED DESCRIPTION OF INVENTION

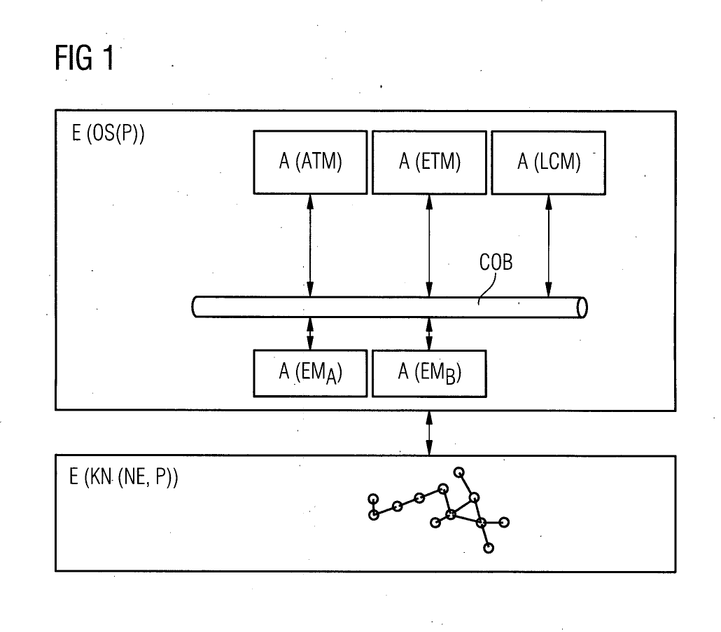

The embodiment of the invention is explained below also with the aid of the exemplary arrangement shown in FIG. 1, which comprises a plurality of physical products E disposed in a distributed manner. The products E are embodied for example as decentralized, distributed network elements NE_{A}, NE_{B} of a communications network KN or as a central operations system OS having applications A for controlling the decentralized elements NE of the communications network KN. The applications A include for example an application ETM (=Ethernet Service Management) for managing Ethernet client channels, an application LCM (=LCAS Management) for managing LCAS server channels or an application ATM (=ATM Management) for integrated management of ATM server and client channels of the communications network KN.

The products E include hardware—in particular processors and storage means—with the aid of which in particular those products E are implemented which are embodied as a computer program product P or, as the case may be, a program P. The hardware can also directly correspond to the products E, for example as an application-specific integrated circuit (ASIC) or equivalent physical product E.

The products embodied as applications A are usually assigned the TMN function blocks Operations Systems Function (OSF) and Workstation Function (WSF), while the products embodied as network elements NE are assigned the TMN function block Network Element Function (NEF).

The operations system OS and the network elements NE are interconnected by means of a data network, referred to in technical circles as a data communication network (DCN), via which e.g. commands for adjusting the bandwidth of channels K are transmitted.

For a first exemplary embodiment of the invention let it be assumed that the communications network KN is a transport network embodied as an SDH network, via which Ethernet channels—also called Ethernet services—are carried.

The SDH network has, inter alia, a server channel K₁ which is embodied as a channel LCAS and, in accordance with the rules of the Link Capacity Adjustment Scheme, permits a dynamic adjustment of its bandwidth by addition and removal of channels VC12 embodied as trails T with the aid of which the bandwidth of the channel LCAS is realized.

The Ethernet services have either a fixed bandwidth (mode: “stream”) or a flexible bandwidth (mode: “best effort”), the latter being characterized, inter alia, by a minimum committed bandwidth and a maximum peak bandwidth. Modem Ethernet services typically have a maximum bandwidth of 100 Mbps (=channel 100Base), 1000 Mbps (=channel 1000Base) or 10 Gbps (=channel 10GbE).

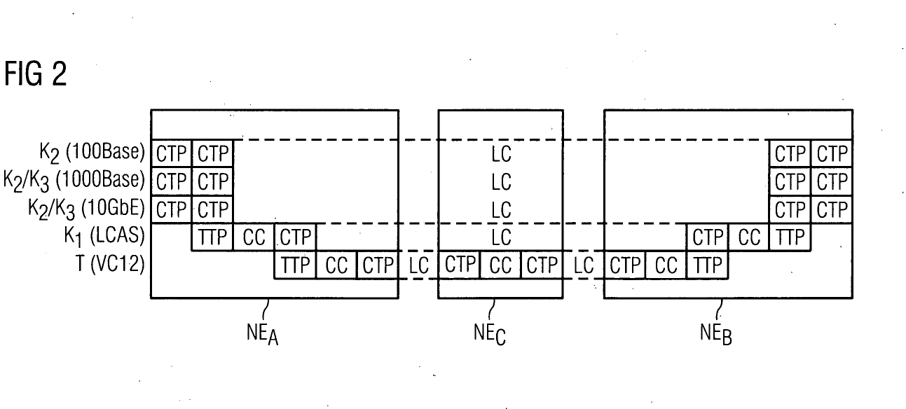

The dependency relations between the channels LCAS and VC12 of the SDH network and the Ethernet channels 100Base, 1000Base and 10GbE are shown in FIG. 2. In this scenario the Ethernet services K₂ can in each case be conveyed either directly or indirectly via the respective higher bit rate Ethernet services K₃ in the channel LCAS. The channels K₂/K₃ represent client channels according to the invention, and the channel K₁ represents a server channel according to the invention. The client channels are inserted into the server channel and transmitted in the SDH network between the network elements NE_{A}, NE_{B} via an intermediate network element NE_{C}.

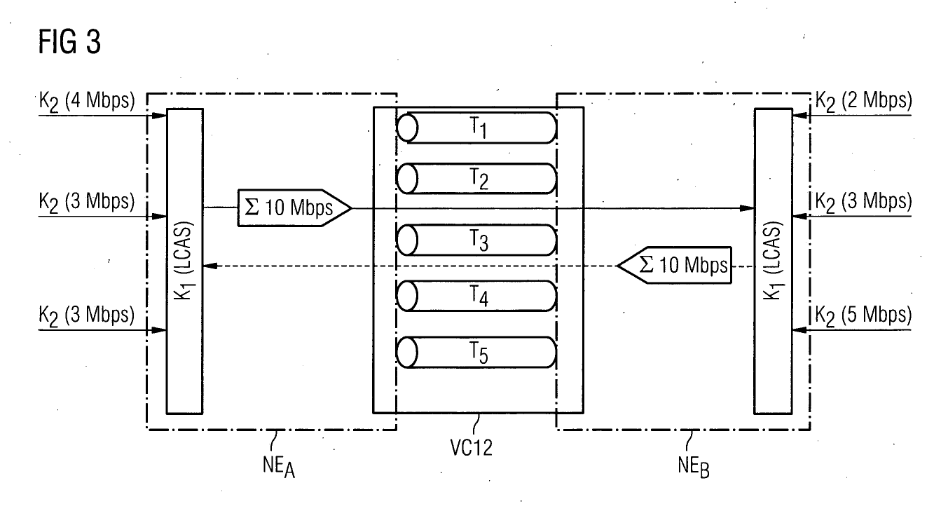

FIG. 3 shows a real case example of this embodiment of the invention. Unidirectional Ethernet services K₂ are inserted into the channel LCAS, with a required bandwidth of 10 Mbps in both transmission directions resulting in purely mathematical terms. In order to implement this bandwidth requirement the channel LCAS is assigned five channels VC12, embodied as trails T₁ to T₅, each with a bandwidth of 2 Mbps, so the channel LCAS has the necessary bandwidth of 10 Mbps. During the transmission the Ethernet services K₂ are automatically distributed over the five channels VC12 by the control logic of the channel LCAS, the distribution being performed transparently with respect to the channels K2, i.e. it is not recognizable for these. The channel LCAS acts on the channels K₂ like a single, homogeneous channel K₁ with a bandwidth of 10 Mbps. In this case the client channels and the server channels are optimally matched with one another in terms of their bandwidth.

The matching of the bandwidths between server and client channels can become less than optimal as a result of changes to the configuration of the communications network KN. This is the case for example when an Ethernet service that uses a channel LCAS as the server channel is created, modified or deleted. According to the invention a situation of this kind is detected and assessed automatically. An automatic change of the bandwidths is initiated as a function of the result of the assessment.

The detection of trigger conditions—also called an event—for an automatic bandwidth adjustment of a server channel can be effected for example in that the necessary bandwidth for the Ethernet services is determined by the operations system OS and monitored against the bandwidth of the server channel LCAS used. If the required bandwidth for the Ethernet services should exceed the current bandwidth configuration of the server channel LCAS or if the bandwidth of the server channel LCAS should not be needed in full, the configuration is automatically adapted provided the requisite resources for this are available. The following options are applicable for said monitoring or, as the case may be, adjustment:

It is triggered for example by a change in respect of the client channels conveyed in a server channel. This could be for example a configuration procedure that is initiated by the application ETH. Said configuration procedure could be for example the creation, modification or deletion of an Ethernet service.

A new bandwidth is calculated for the server channel affected. If the new bandwidth exceeds or falls below certain preset threshold values, an adjustment of the bandwidth of the server channel is initiated. By means of this hysteresis the number of adjustments of the bandwidth of server channels is advantageously reduced.

It is configurable (in/out per channel LCAS). In this way the QoS (Quality of Service) of the Ethernet services can advantageously be mapped—adjust for “stream” and no adjust for “best effort” services.

The possible delta (bandwidth of the fragment paths—2 Mbps per channel VC12 in the example)—with which the bandwidth can be adjusted is taken into account.

Possible overheads arising during the transmission of the services (e.g. headers of the Ethernet packets and/or such that are formed according to the Generic Framing Procedure GFP) are taken into account in the calculation of the bandwidth available for the services.

In the case of second channels with flexibly varying bandwidths the new bandwidth is calculated at least sufficiently large so that a probable loss rate, determined taking into account the statistical distribution of the bandwidth variations, is equal to or less than a predefined probable loss rate.

Client-server relations are taken into account over several stages. The monitoring covers not only the required bandwidth for the direct client channels, but also that required indirectly via the mediation of a plurality of client-server relations. For example, a channel 100Base can be conveyed directly in the channel LCAS or indirectly via channels 1000Base and/or 10GbE in the channel LCAS. Alternatively (not shown in the figures) a channel LCAS can be the server for a group channel with sub-channeling according to the Generic Framing Procedure, and the group channel is in turn the server channel for the Ethernet services, with the result that the channel LCAS and the Ethernet services are merely indirectly engaged in a client-server relation with one another.

A check is carried out to determine whether there are still sufficient free capacities available in the communications network KN for a desired adjustment—in particular increase—in the bandwidth of a channel. The user is only asked whether the bandwidth is to be adjusted if the required resources are available in the network.

Following a trigger condition detected and evaluated in this way the bandwidth of the affected server channel K₁ is automatically adjusted by the operations system OS. This is effected for example by the application LCM. The following options are applicable here:

The number of channels VC12 that need to be added or deleted for the bandwidth adjustment is determined, taking into account additional overheads.

The network resources for both ends of the server channel LCAS are modified. This modification is preferably effected via the respective element managers EM_{A}, EM_{B}.

New channels VC12 are routed with the aid of the operations system OS.

All the necessary configurations are activated in the communications network KN.

Hardware restrictions are taken into account, e.g. the maximum number of possible channels VC12 that are supported by a channel LCAS, free slots within a channel VC4, and in particular the order in which the modifications must be carried out.

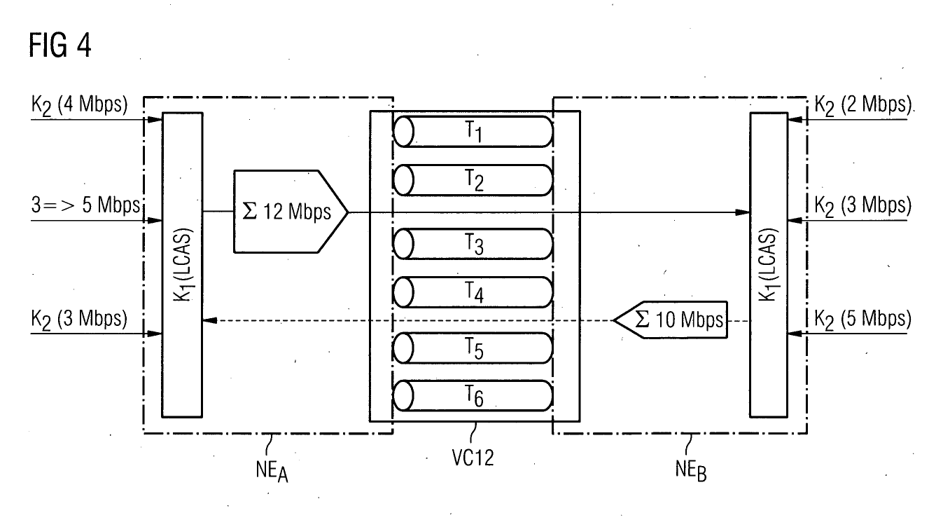

FIG. 4 shows by way of example how the configuration from FIG. 3 is modified following a thus effected adjustment of the bandwidth of the channel LCAS initiated by an increase in the bandwidth of one of the unidirectional Ethernet services from NE_{A} to NE_{B} from 3 Mbps to 5 Mbps. As a consequence of this event a required new bandwidth of 12 Mbps is determined and an adjustment request in respect of the channel LCAS initiated. Upon checking the request it is established that an additional channel VC12, embodied as trail T₆, is required. This is routed in the communications network KN by the operations system and checked with regard to the resources still available as well as other ancillary conditions. Once a positive result of the check has been established the bandwidth of the channel LCAS is expanded by the bandwidth of trail T₆ in that the newly configured trail T₆ is added to the channel LCAS as a new server channel. Following completion of this automatic bandwidth adjustment the channel LCAS has, as shown in FIG. 4, a new bandwidth of 12 Mbps, the full capacity of which is used in one direction and 10 Mbps of which is used in the opposite direction. For the sake of simplifying the exemplary embodiment, overheads requiring to be factored in (e.g. those for GFP) are not shown.

By means of the automatic bandwidth adjustment it is made advantageously possible to map the flexibility of the Ethernet in respect of bandwidth and QoS to transport networks. This succeeds in a particularly elegant manner if the use of the required bandwidth as a trigger for the automatic expansion of a server channel is based on the following points:

The definition of rules for monitoring required and available network capacities as well as of trigger conditions which can be monitored by the operations system.

The definition of the processes that are performed by the management system during a bandwidth adjustment.

In an alternative exemplary embodiment the communications network KN is embodied as an ATM network, the client channels are embodied as virtual connections (VCs) and the server channels as virtual paths (VP).

When a new VC is generated it is first checked in this example whether a VP to the destination of the new VC is already set up. If this is not the case, a new VP is configured whose bandwidth is chosen at least sufficiently large so that the new VC can be conveyed in the new VP.

If a VP already exists, its bandwidth is checked. If the bandwidth is not sufficient also to convey the new VC in the VP, a required new bandwidth for the VP is calculated in accordance with the above-listed criteria. Next, a check is made—preferably by the application ATM—for all affected network elements NE to determine whether sufficient resources are still available in the communications network KN for an increase in the bandwidth of the VP. This check can be performed both by the operations system OS and by the network elements NE. If the check yields a positive result, the bandwidth of the VP in the ATM network is increased to the new bandwidth.

In both cases the bandwidth of the VP is subsequently sufficiently large to enable the new VC to be conveyed in the VP.

Particularly attractive advantages result with regard to an optimal use of the available network resources if it is continuously attempted—i.e. beginning already with the setting up of a first client channel—to make the bandwidth of the server channel correspond as precisely as possible to the aggregated bandwidth of the client channels conveyed therein. In this way the unused capacity that is tied up by already created but not yet fully loaded server channels with high bandwidth is minimized.

According to a further variant of the invention, a change of bandwidth can also be initiated by a direct configuration job of an operator of the communications network. In this case the user must advantageously specify only the desired bandwidth, instead of performing all the necessary configuration steps manually. With the aid of the defined rules the system calculates the number of channels VC12 to be added/deleted and implements the necessary configurations automatically on the basis of the defined processes.

A multiplicity of further advantages are associated with the invention:

The Ethernet and transport technologies are combined with one another in terms of bandwidth and QoS.

Use of the bandwidths in the communications network is optimized. Less capacity is tied up by non-optimally filled server channels.

Economic advantages are produced for a network operator through a reduction in OPEX (OPerational EXpenses).

An implementation of the invention necessitates no changes in principle to the existing prior art, but essentially can be inserted retroactively as a component or module—in particular as a modified or additional computer program product.

The time of implementation is independent of the time of implementation of other functions.

By means of the invention it is ensured that the individual components of the overall system are subjected to load only to a minor extent and consequently the stability of the overall system is increased.

In conclusion it should be pointed out that the description of the system components relevant to the invention is fundamentally not to be understood as limiting in terms of a specific physical implementation or assignment. It is obvious in particular for a person skilled in the relevant art that the invention can be realized partially or fully in software or, as the case may be, as a computer program product. It is also clear to the person skilled in the art that the invention can be realized both by a single product by which the invention is performed in its entirety and in a distributed manner by appropriate interaction of a plurality of products by which parts of the invention are performed in each case.

1.-10. (canceled)

11. A method for adjusting the bandwidth of transmission channels of a communications network, the communication network comprising a server channel and a client channel, the client channel is conveyed in the server channel, the method comprising:
requesting an adjustment in respect of the server channel in response to an event triggering the request with regard to the client channel conveyed in the server channel;
determining a new bandwidth taking into account the client channel; and
adjusting of the bandwidth of the server channel.

12. The method as claimed in claim 11, wherein the determination of the new bandwidth is via a product embodied as a central operations system.

13. The method as claimed in claim 12, wherein the adjustment request is initiated by an insertion the client channel into the server channel or by a removal of the client from the server channel.

14. The method as claimed in claim 13, further comprising:
checking whether a suitable server channel exists in the communication network which leads to the destination of the new client channel and in which the new client channel could be conveyed prior to generating a new client channel, and
setting up a new server channel to the destination in response to a suitable server channel not existing, the new client channel is subsequently conveyed in the new server channel

15. The method as claimed in claim 11, wherein the adjustment request is initiated by an insertion the client channel into the server channel or by a removal of the client from the server channel.

16. The method as claimed in claim 11, further comprising:
checking whether a suitable server channel exists in the communication network which leads to the destination of the new client channel and in which the new client channel could be conveyed prior to generating a new client channel, and
setting up a new server channel to the destination in response to a suitable server channel not existing, the new client channel is subsequently conveyed in the new server channel

17. The method as claimed in claim 11,
wherein the communication network comprises a plurality of client channels,
wherein at least a portion of the client channels are indirectly conveyed in the server channel and are conveyed directly in a third channel, and
wherein the third channel is conveyed in the server channel.

18. The method as claimed in claim 17, wherein the indirect conveyability further extends over a plurality of stages of third channels conveyed in one another in each case.

19. The method as claimed in claim 17, wherein a flexibly variable bandwidth or a constant bandwidth is taken into account in the determination of the new bandwidth for a client channel.

20. The method as claimed in claim 11, wherein a flexibly variable bandwidth or a constant bandwidth is taken into account in the determination of the new bandwidth for a client channel.

21. The method as claimed in claim 11, further comprising determining whether there are sufficient free resources in the communications network for adjusting the bandwidth of the server channel.

22. A computer-readable medium for a product of a communications network, the computer-readable medium having computer-executable instructions for performing acts comprising:
requesting an adjustment in respect of a server channel in response an event triggering the request with regard to a client channel conveyed in the server channel;
determining a new bandwidth taking into account the client channel; and
adjusting of the bandwidth of the server channel.
